(19) United States
(12) Patent Application Publication
(10) Pub. No.: US 2002/0102523 A1
(43) Pub. Date: Aug. 1, 2002

(54) System and method for verifying compliance with examination procedures

(75) Inventor: Daniel Pelletier, Lake Peekskill, NY (US)

Correspondence Address: Jack E. Haken, c/o U. S. PHILIPS CORPORATION, Intellectual Property Department, 580 White Plains Road, Tarrytown, NY, 10591, US

(73) Assignee: Philips Electronics North America Corporation

(21) Appl. No.: 09/772,481

(22) Filed: Jan. 29, 2001

(51) Int. Cl. G09B 7/00

(52) U.S. Cl. 434/323

(57) ABSTRACT

A system and method for verifying compliance with predetermined examination procedures. The system comprises at least one examination site data processing system comprising a data processing device, a user interface in data communication with the data processing device, and a recording device for recording audio and video information about the examination site and a user, and a central data processor in data communication with the data processing device of the examination site data processing system. The central data processor is configured to correlate video and audio data received from the examination site data processing device with user data inputted into the user interface in order to determine whether the user is complying with predetermined examination procedures.

### BACKGROUND OF THE INVENTION

1. Field of the Invention

The present invention generally relates to a system and a method for verifying compliance with examination procedures.

2. Problem to be Solved

The Internet has exposed people all over the world to a vast source of opportunities in the areas of employment and education. The global economy has fueled this source of opportunities. Persons, no matter where located, now have the opportunities to become associated with multi-national corporations or other organizations, or apply for admission to academic institutions. In many instances, pre-qualifying or qualifying examinations or tests are administered to determine whether the applicant is a suitable candidate for a particular position within an organization. Many academic institutions also require applicants to take a qualifying examination.

Applicants for employment or admission to an academic institution may be located at significant distances from the site of the qualifying examination or test. Travel costs, unless reimbursed, can deprive or dissuade a prospective applicant from taking the examination. Furthermore, the travel time to the examination site also can deprive or dissuade an applicant from taking such examinations or tests. On the other hand, the organization or institution providing the examination may not have the facilities for providing an examination to a large number of people.

What is needed is a system that enables remotely located applicants to take qualifying examinations or tests and monitors the applicants during the examination to ensure the applicants are complying with predetermined examination guidelines and procedures.

### SUMMARY OF THE INVENTION

In one aspect, the present invention is directed to a system for verifying compliance with predetermined examination procedures. The system comprises at least one examination site data processing system comprising a data processing device, a user interface in data communication with the data processing device, and a recording device for recording audio and video information about the examination site and a user, and a central data processor in data communication with the data processing device of the examination site data processing system. The central data processor is configured to correlate video and audio data received from the data processing device with data inputted into the user interface in order to determine whether the user is complying with predetermined examination procedures.

In another aspect, the present invention is directed to a method for verifying compliance with predetermined examination procedures, comprising the steps of providing at least one examination site data processing system comprising a data processing device and a user interface that allows the user to input data in response to examination questions, generating data defining an examination and routing the data to the data processing device, using the user interface to respond to examination questions and generating corresponding examination response data, visually monitoring the examination site and the user during the examination period and generating corresponding video data, audibly monitoring the examination site and user during the examination period and generating corresponding audio data, and correlating the visual and audio data with the examination response data to determine if the user is complying with predetermined examination procedures.

### BRIEF DESCRIPTION OF THE DRAWINGS

The features of the invention are believed to be novel and the elements characteristic of the invention are set forth with particularity in the appended claims. The invention itself, both as to organization and method of operation, may best be understood by reference to the detailed description which follows taken in conjunction with the accompanying drawings in which:

FIG. 1 is a block diagram of one embodiment of the system of the present invention.

FIG. 2 is a block diagram of another embodiment of the system of the present invention.

### DETAILED DESCRIPTION OF THE INVENTION

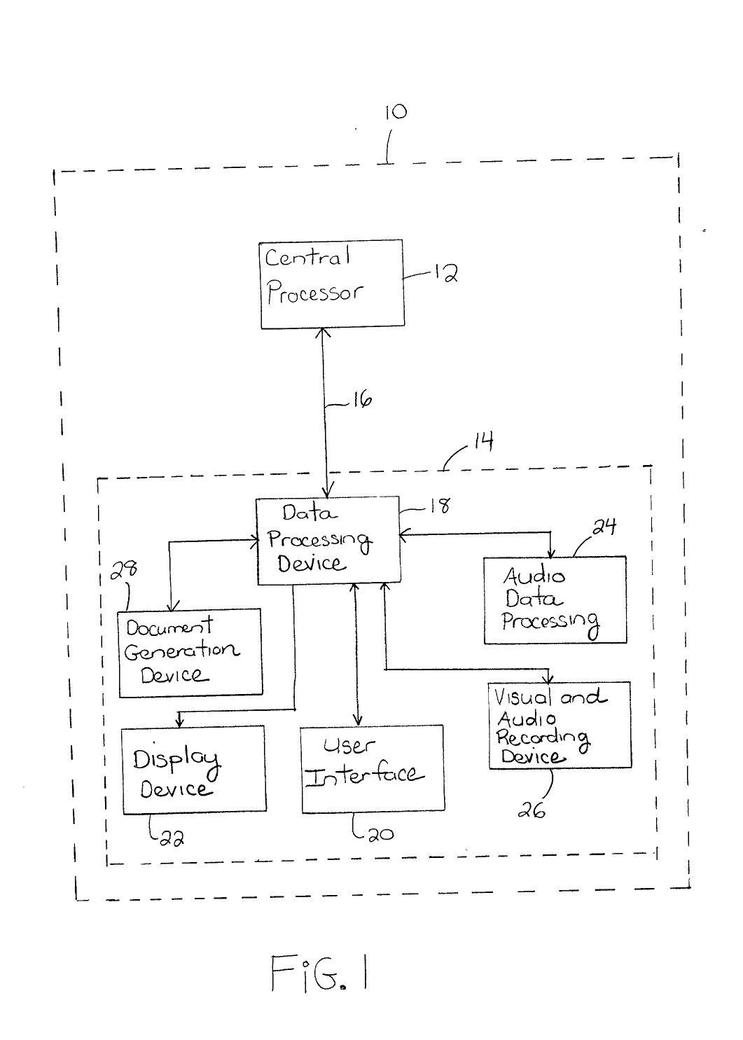

Referring to FIG. 1, there is shown system 10 of the present invention. System 10 generally comprises central processor or controller 12 and examination site data processing system 14. In one embodiment, central processor 12 is remotely located with respect to data processing system 14. Central processor 12 is in data communication with data processing system 14 via data communication link 16. In one embodiment, link 16 is realized by an Internet connection using a publicly switched phone network such as those provided by a local or regional phone company. However, it is to be understood that data communication link 16 can realized as dedicated data lines, cellular, personal communication (“PCS”), microwave or satellite network. In one embodiment, data processing system 14 includes a modem (not shown) that effects data communication between data processing system 14 and central processor 12.

Referring to FIG. 1, central processor 12 can be located at remote location or in proximity to data processing system 14. In one embodiment, central computer 12 includes a central processing unit or CPU (not shown), memory devices such as random-access-memories or read-only memories (not shown) clock circuitry (not shown) and a data storage device (not shown) having sufficient storage capacity to archive examination data for a desired length of time (e.g. 5 years). The data storage device may include hard disk magnetic or optical storage units as well as CR-ROM drives or flash memory. A conventional personal computer or computer work station with sufficient memory and processing capability may be used as central controller 12. In one embodiment, central controller 12 operates as a web server, both receiving and transmitting data from and to, respectively, data processing system 14. Central controller 12 includes a user interface (not shown) to enable programming of the CPU as well as to input specific data to be routed to data processing system 14. Central controller 12 is configured to process relatively large data wherein such data includes audio and video data. Commercially available microprocessors produced by Intel Inc., Motorola or Sun Microsystems can be used to realize the CPU of central controller 12.

Referring to FIG. 1, examination site data processing system 14 generally comprises data processing device 18 and user interface 20. Data processing device 18 can be realized by a personal computer, lap top or notebook computer. User interface 20 can be realized by commercially available computer keyboard and a computer mouse. Data processing device 14 further includes visual display device 22 that is in data communication with data processing device 18. In one embodiment, display device 22 is configured as a commercially available computer monitor. Data processing system 14 further includes audio data processing device 24 which is in data communication with data processing device 18. Audio presentation device 24 provides audio information that has been processed by data processing device 18. In one embodiment, audio processing device 24 comprises a commercially available audio sound card and speaker.

Referring to FIG. 1, data processing system 14 further comprises video and audio recording device 26 that is in data communication with data processing device 18. Video and audio recording device 26 generally comprises a video recording device, such as a video camera, and a microphone for detecting acoustic signals, and an interface to effect transfer of video and audio data to data processing device 18. In one embodiment, video and audio recording device 26 comprises a commercially available video camera. In another embodiment, video and audio recording device 26 is configured as an audio and video conferencing system, such as the type described in U.S. Pat. Nos. 6,125,398 and 6,134,223, the disclosures of which are incorporated herein by reference. In a preferred embodiment, video and audio recording device 26 is configured to record the movement and associated sounds of the user (i.e. the person taking the examination) during the examination period. Preferably, device 26 provides for wide-angle viewing of the particular area or work station at which the user is taking the examination.

Referring to FIG. 1, data processing system 14 further comprises document generation device 28 that is in data communication with data processing device 18. Device 28 can be realized by any one of the commercially available computer printing devices such as laser jet, ink jet or dot matrix printers. In a preferred embodiment, device 28 is configured to provide an option for a visually impaired person to have documents produced in Braille format.

Each step of the method of the present invention is described in the ensuing description.

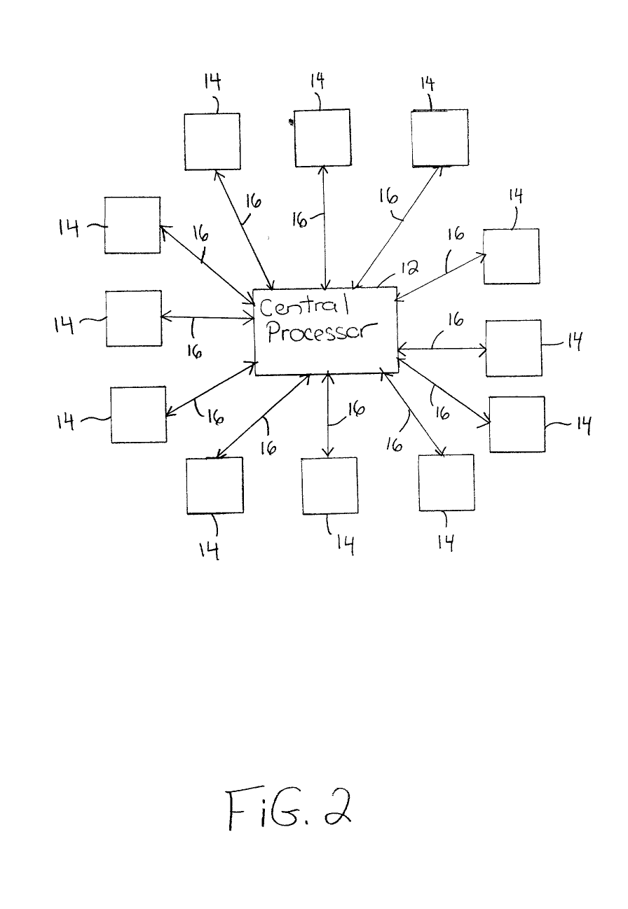

The first step of the method of the present invention is to provide central processor 12 and at least one examination site data processing system 14. It is to be understood that there can be a plurality of examination site data processing system 14. The plurality of systems 14 can be located at one location, or each system 14 can be located at a different location. Such a configuration is shown in FIG. 2. Central processor 12 is remote from the plurality of systems 14. Central processor 12 is in data communication with the systems 14 via data communication links 16.

The next step of the method of the present invention entails providing data defining an examination and routing this data to each system 14. In one embodiment, information defining the examination is inputted into central processor 12 via a user interface (not shown). The data defining the examination is routed to the data processing device 18 of each system 14 which then effects display of the data on display device 22 and/or generation of sound or verbal commands via audio data processing device 24. In one embodiment, central processor 12 includes voice recognition circuitry. In such a configuration, central processor 12 issues a request to system 14 that requires the user to speak a particular sentence or phrase that is detected by visual and audio recording device 24. Central processor 12 then stores the data associated with the spoken sentence or phrase and is used to determine whether that particular user is the person actually answering the questions if verbal responses to examination questions are required.

In the next step, the examination period begins and the user (e.g. examination taker) begins taking the exam. In one embodiment, the user uses interface 20 to input responses to the examination. If the examination requires verbal responses, the user can verbally respond to questions appearing on display device 22. Such verbal responses are received by the microphone in video and audio recording device 26. In one embodiment, the verbal responses received by the microphone are inputted into data processing device 18 which then routes the verbal responses to central processor 12. Central processor 12 then processes the verbal responses. In an alternate embodiment, the verbal responses received by the microphone are processed by data processing device 18.

In an alternate embodiment, the user can use document generation device 28 to produce a hard copy of the examination. If the user is visually impaired, device 28 can be configured via interface 20 to provide a Braille version of the examination. In such a configuration, the user either verbally responds to the examination questions or uses a keyboard having Braille notation thereon.

Next, video and audio recording device 26 monitors system 14, the user and all sounds in the vicinity of the user. Specifically, the camera of video and audio recording device 26 records all physical movements of the user during the examination period. Such physical movements include any physical contact between the user and interface 20 (e.g. keyboard, mouse, etc.), visual display 22 and document generation device 28. The microphone of video and audio recording device 26 receives any acoustic signals in the vicinity of the user such as the voice of the user or the voice of a third party in proximity to the user. Central processor 12 receives the acoustic signals recorded by device 26 and processes the acoustic signals to determine whether a user is using any reference material to aid him/her in taking the examination. Video and audio recording device 26 also generates audio and video data that is used by central processor 12 to determine whether the user is using an additional computer or device (e.g. lap top, notebook, etc.) or spoken instructions from a third party. Data processing device 18 automatically routes data generated by video and audio recording device 26 to central processor 12 wherein such data is processed. Thus, central processor 12 can detect whether a user is using an alternate device to aid him/her in taking the examination while merely making mock movements of the keyboard and/or mouse.

In an alternate embodiment, data processing device 18 receives the acoustic signals recorded by device 26 and processes the acoustic signals to determine whether a user is using any reference material to aid him/her in taking the examination. In such a configuration, data processing device 18 outputs a signal to central processor 12 that indicates whether the user is using any reference material.

Once central processor 12 determines that the user is not complying with examination procedures, central processor 12 generates and displays information that informs the personnel administering the examination that a particular person taking the examination may not be complying with examination procedures and that such person should be closely monitored. In one embodiment, system 10 includes a monitor or display device that allows the personnel administering the examination to monitor the person in question in real time.

In the next step, central processor 12 correlates the data generated by video and audio recording device 26 with the user's responses to the examination. The results of the correlation is then compared to predetermined examination procedures or guidelines in order to determine if the user is complying with such procedures.

The following example illustrates the foregoing step:

### EXAMPLE

1) Predetermined examination procedures:

a) closed book examination (no reference materials or other devices permitted);

b) examination shall be displayed on visual display device 22; and

c) the user shall respond by using keyboard and/or mouse.

2) The user uses a reference book while taking the examination.

3) Video and audio recording device 26 records an object (i.e. the reference book) other than the keyboard or mouse, and user hand movement which is not commensurate with the detected movement of the computer keyboard or mouse. The audio and video data generated by device 26 is inputted into central processor 12.

4) Central processor 12 correlates the video data relating to the additional object and hand movement with the user's movement while inputting examination responses via user interface 20 (i.e. keyboard or mouse).

5) Central processor 12 determines that there is a relatively high probability that the user is not complying with the examination procedures and issues a notice to system 14 so as to inform the user to cease taking the examination and to wait until further instructions by the personnel administering the examination. In an alternate embodiment, central processor 12 generates and displays information that informs the personnel administering the examination that the user may not be complying with examination procedures and that such user should be closely monitored. The personnel administering the examination then monitor the user in real time while the user continues to take the examination.

Thus, the present invention uses a multi-modal (e.g. computer vision/speech) system to observe a user in progress taking a qualifying test. System 10 detects compliance with examination procedures by visually and audibly monitoring the user while taking the examination and correlating that data with user interface events such as mouse press, keypress, spoken commands, gestual commands, etc. to determine the probability that the user is the person actually taking the examination or whether the user is complying with predetermined guidelines and procedures. System 10 can detect whether the user is using any reference material to assist the user in taking the examination. The CPU of central processor 12 is programmed with the appropriate algorithms to effect correlation between the audio and video data and the user's examination responses.

System 10 of can be used to provide on-line examination for students, job applicants, etc. that are located anywhere in the world and ensures that the users are taking the examination fairly without outside assistance and that they themselves are answering questions and responding physically in ways that correlate correctly with the responses given by the user.

The present invention can be embodied in the form of computer processor readable program code embodied in a computer processor usable medium, such as floppy diskettes, CD-ROMs, hard drives, or any other computer-readable storage medium, wherein, when the computer program code is loaded into and executed by a computer, the computer becomes an integral part of an apparatus or system for practicing the invention.

The principals, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations in changes may be made by those skilled in the art without departing from the spirit of the invention. Accordingly, the foregoing detailed description should be considered exemplary in nature and not limited to the scope and spirit of the invention as set forth in the attached claims.

Thus, having described the invention, what is claimed is:

1. A system for verifying compliance with predetermined examination procedures, comprising:
at least one examination site data processing system comprising a data processing device, a user interface in data communication with the data processing device, and a recording device for recording audio and video information about the examination site and a user; and
a central data processor in data communication with the data processing device of the examination site data processing system, the central data processor being configured to correlate video and audio data received from the examination site data processing device with user data inputted into the user interface in order to determine whether the user is complying with predetermined examination procedures.

2. The system according to claim 1 wherein the data processing device of the examination site system comprises a personal computer.

3. The system according to claim 1 wherein the device for recording video and audio information comprises a camera in data communication with the data processing device.

4. The system according to claim 1 wherein the device of the examination site system comprises a microphone for receiving acoustic information in the vicinity of the examination site.

5. The system according to claim 1 wherein the examination site data processing system further comprises a device for displaying examination-related data to the user.

6. The system according to claim 1 wherein the display device comprises a monitor.

7. The system according to claim 1 wherein the user device comprises a computer keyboard.

8. The system according to claim 1 wherein the user interface comprises a computer mouse.

9. The system according to claim 1 wherein the examination site system comprises an audio speaker for allowing the user to hear verbal instructions or commands issued from the central data processor.

10. The system according to claim 1 wherein the at least one examination site data processing system comprises a plurality of examination site data processing systems and the central data processor comprises a central computer at a remote location with respect to the examination site system.

11. The system according to claim 1 wherein the examination site system further comprises means for providing a hard copy of an examination to be taken by the user.

12. A method for verifying compliance with predetermined examination procedures, comprising the steps of:
providing at least one examination site data processing system comprising a data processing device and a user interface that allows the user to input data in response to examination questions;
generating data defining an examination and routing the data to the data processing device;
using the user interface to respond to examination questions and generating corresponding examination response to data;
visually monitoring the examination site and the user during the examination period and generating corresponding video data;
audibly monitoring the examination site and user during the examination period and generating corresponding audio data; and
correlating the visual and audio data with the examination response data to determine if the user is complying with predetermined examination procedures.

13. The method according to claim 12 wherein the generating step comprises the step of displaying the examination data to the user.

14. The method according to claim 12 further including the step of presenting audio instruction to the user.

15. An article of manufacture, comprising a computer processor usable medium having computer processor readable program code embodied therein for verifying that the user is complying with predetermined examination procedures using a system comprising a central data processor, and at least one examination site data processing system comprising a data processing device in data communication with the central data processor, a user interface in data communication with the data processor and a device for recording video and audio information about the examination site and the user during the examination period, the computer processor readable program code in the article of manufacture comprising:
computer processor readable program code configured to cause the system to generate data defining an examination and routing the data to the data processing device;
computer processor readable program code configured to cause the system to enable the central data processor system to receive examination response data from the user interface;
computer processor readable program code configured to cause the system to visually monitor the examination site and the user during the examination period and generate corresponding video data;
computer processor readable program code configured to cause the system to audibly monitor the examination site and the user during the examination period and generate corresponding audio data; and
computer processor readable program code configured to cause the central data processing system to correlate the video and audio data with the examination response data to determine if the user is complying with predetermined examination procedures.
